(19) United States
(12) Patent Application Publication
(10) Pub. No.: US 2026/0267770 A1
(43) Pub. Date: Sep. 10, 2026

(54) SYSTEM AND METHOD FOR AGENTIC ARTIFICIAL INTELLIGENCE

(71) Applicant: Fairly AI, Kitchener (CA)

(72) Inventors: David van Bruwaene, Kitchener (CA); Hassan Patel, Kitchener (CA); Ahmed Husseini Orabi, Kitchener (CA); Mahmoud Husseini Orabi, Kitchener (CA); Samantha Chan, Kitchener (CA)

(73) Assignee: Fairly AI, Kitchener (CA)

(21) Appl. No.: 19/070,011

(22) Filed: Mar. 4, 2025

(51) Int. Cl. G06F 11/3604

(52) U.S. Cl. CPC G06F 11/3608

(57) ABSTRACT

What is disclosed is: A method for agentic AI comprising: identifying, by an evaluation agent, one or more objectives for an evaluation of a target AI program; determining, by the evaluation agent, one or more steps to perform the evaluation based on the identified objectives; performing, by the evaluation agent in combination with a red team agent and a conversation team director, the evaluation; and generating, based on the performing of the evaluation, output reporting.

### FIELD OF THE INVENTION

The present disclosure relates to agentic and multi-agent artificial intelligence systems.

### BRIEF SUMMARY

An agentic artificial intelligence (AI) evaluation system comprising: a plurality of agents further comprising: a red team agent communicatively coupled via a network to a target agent, a conversation director agent, and an evaluation agent, wherein: the red team agent, the conversation director agent, and the evaluation agent are communicatively coupled to each other via one or more interconnections; the evaluation agent identifies one or more objectives for an evaluation; the evaluation agent determines one or more steps to perform the evaluation based on the identified objectives; the evaluation is performed by the evaluation agent either on its own or in combination with the red team agent and the conversation team director; and based on the performance of the evaluation, output reporting is generated.

A method for agentic AI comprising: identifying, by an evaluation agent, one or more objectives for an evaluation of a target AI program; determining, by the evaluation agent, one or more steps to perform the evaluation based on the identified objectives; performing, by the evaluation agent in combination with a red team agent and a conversation team director, the evaluation; and generating, based on the performing of the evaluation, output reporting.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 is an illustration of an example embodiment of an artificial intelligence (AI) evaluation system.

FIG. 2 is an illustration of an example embodiment of a development device.

FIG. 3 is an illustration of a detailed embodiment of an AI evaluation system.

FIG. 4 is an illustration of an example embodiment of an agentic AI evaluation system.

FIG. 5 is an illustration of an example embodiment of a process flow for evaluation of one or more target agents.

FIG. 6 is an illustration of an example embodiment of a process flow for automated adversarial testing of one or more target agents.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Agentic artificial intelligence systems ingest vast amounts of data form multiple sources to independently analyze challenges, develop strategies and execute tasks. These systems use sophisticated reasoning and iterative planning to continuously and autonomously solve complex problems.

Some agentic AI systems use multiple types of AI agents that work together to achieve more complex tasks. An AI agent refers to a system or program that is capable of autonomously performing tasks on behalf of a user or another system by designing its workflow and utilizing available tools, all without human intervention. In some embodiments, AI agents are implemented using specialized hardware such as AI accelerator hardware and processing units developed by corporations such as INTEL, NVIDIA and AMD. Examples include the NVIDIA H100 Tensor Core GPU. In some embodiments, the AI agents can be trained and tested using algorithms known to those of ordinary skill in the art and massive data sets.

Some of these AI agents may utilize generative AI. Generative AI is AI that can create original content such as text, images, video, audio or software code in response to a user's prompt or request. Some of these generative AI agents are large language model (LLM)-based. These LLM-based agents are able to reason through a problem, create a plan to solve the problem, and execute the plan with the help of a set of tools in response to user prompts.

The process of designing and providing specific prompt texts to generate desired responses or complete specific tasks is prompt engineering. Then, users utilize prompt engineering approaches to create prompts and guide LLMs in generating desired responses or completing specific tasks. For example: a prompt is designed using prompt engineering to supply a problem to an LLM-based agent. The LLM-based agent determines the tasks necessary to solve the problem, breaks the tasks down into subtasks, and creates a plan involving workflows to execute these subtasks. This plan is then executed using a set of tools.

An example of an AI agent which uses generative AI is a chatbot which uses generative AI to simulate human conversation or chatter through text or voice interactions.

Some AI agents are multimodal. These agents are capable of working with data in a plurality of modes, such as text, image and audio modes. In general, multimodal systems comprise one or more of the following:
The inputs to, and outputs from the system are of different modalities, for example, text-to-image, image-to-text;
The inputs are multimodal, for example, a system that can process both text and images; and
The outputs from the system are multimodal, for example, a system that can generate both text and images.

Performance evaluation of agents and multimodal agents is performed in a variety of ways. For example, different benchmarks relating to accuracy, bias, fairness, safety, security, privacy, ethical challenges and reliability are used for evaluation.

It is extremely useful to perform multimodal evaluation via multimodal testing. Examples of activities which form part of multimodal testing are:
Cross-modal agent testing, that is, testing across various modes;
Consistency across input/output modes;
Evaluating of agents in multimodal environments; and
Testing for instruction-following in multimodal tasks.

It is necessary to generate sufficient multimodal content for testing. Two key parts of multimodal content generation are:
Cross-modal instruction adherence, which includes, for example:
   Generating and evaluating content across modes such as text, images and audio, and
   Ensuring consistency with task instructions; and
Testing agent response accuracy, which includes, for example:
   Comparing generated content against expected output, and
   Identifying mismatches in content relevance across modes.

In some embodiments, agentic AI systems also comprise a multi-agent system, where a collection of one or more types of AI agents work together to solve complex tasks.

In agentic AI, firstly AI agents gather and process data from various sources, such as sensors, databases and digital interfaces. This involves extracting meaningful features, recognizing objects or identifying relevant entities in the environment.

These systems have an orchestrator, or reasoning engine, that understands tasks, generates solutions and coordinates specialized models for specific functions like content creation, vision processing or recommendation systems. This step uses techniques like retrieval augmented generation (RAG) to access proprietary data sources and deliver accurate, relevant outputs.

By integrating with external tools and software via application programming interfaces, agentic AI can quickly execute tasks based on the plans it has formulated. In some embodiments guardrails are built into AI agents to help ensure they execute tasks correctly. For example, a customer service AI agent processes claims up to a certain amount, while claims above the amount have to be approved by a human.

Agentic AI continuously improves through a feedback loop, where the data generated from its interactions is fed into the system to enhance models. This ability to adapt and become more effective over time offers businesses a powerful tool for driving better decision-making and operational efficiency. This feedback loop could be implemented using millions and even billions of data points, which as would be appreciated by one of ordinary skill in the art is well beyond the capability of humans.

The prior art does not contemplate the use of agentic AI or multi-agent systems to perform multimodal evaluation of AI agents. A system and method for multi-agent multimodal evaluation of AI agents which overcomes many of the shortcomings of the prior art is presented below.

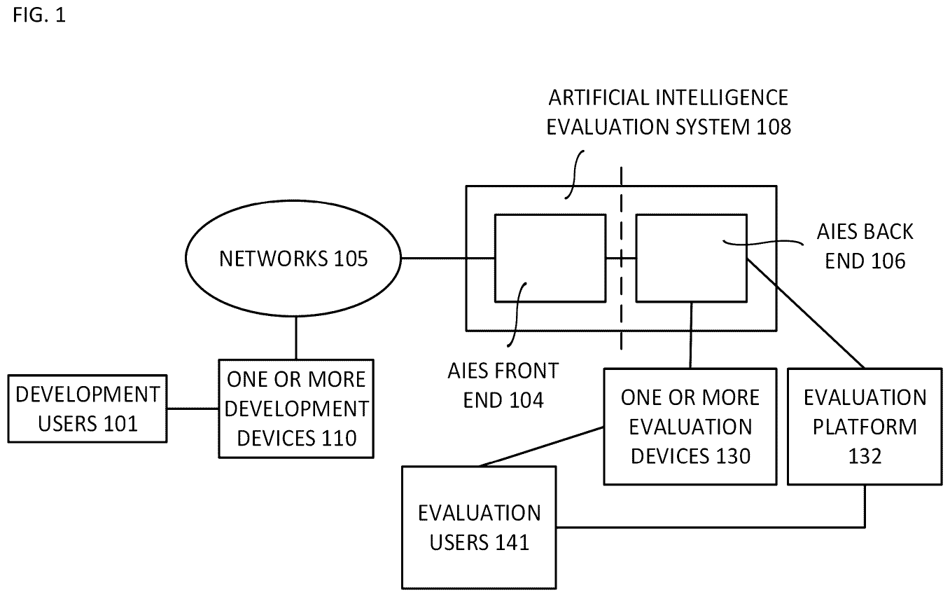

FIG. 1 shows a block diagram of an artificial intelligence evaluation system (AIES). In FIG. 1, system 100 comprises development users 101 who interact with one or more development devices 110. These development devices 110 are communicatively coupled via networks 105 to an artificial intelligence evaluation system (AIES) 108. AIES 108 comprises an AIES front end 104 and an AIES back end 106. The AIES back end 106 is communicatively coupled to one or more evaluation devices 130, which are used by evaluation users 141. The AIES back end 106 is also connected to an evaluation platform 132. This architecture enables separation between development and evaluation functions, with networks 105 providing secure communication channels between the various components. The development users 101 submit AI agents for evaluation through their development devices 110, while evaluation users 141 conduct assessments using evaluation devices 130 in conjunction with the evaluation platform 132. In FIG. 1, in system 100, one or more development devices 110 are coupled to networks 105.

In some embodiments, AIES 108 is part of a larger overall system, such as a RAG system or a generative AI system.

One or more development devices 110 are associated with development users 101. Development users 101 are, for example, part of a development team. These include, for example, smartphones, tablets, laptops, desktops or any appropriate computing and network-enabled device used for AI or ML model development. In some embodiments, one or more development devices 110 are communicatively coupled to networks 105 so as to transmit communications to, and receive communications from networks 105. One or more development devices 110 are coupled to the other components of system 100 via networks 105.

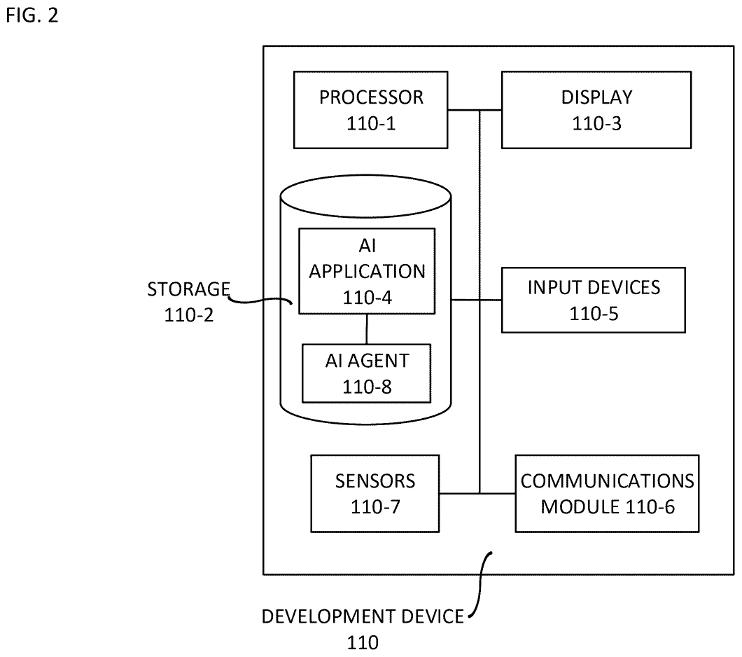

An example embodiment of one of the one or more development devices 110 is shown in FIG. 2. In FIG. 2, processor 110-1 performs processing functions and operations necessary for the operation of one of the one or more development devices 110, using data and programs stored in storage 110-2. An example of such a program is AI/ML application 110-4, which will be described in further detail below. Display 110-3 performs the function of displaying data and information for user 101. Input devices 110-5 allow one of the development users 101 to enter information. This includes, for example, devices such as a touch screen, mouse, keypad, keyboard, microphone, camera, video camera and so on. In some embodiments, display 110-3 is a touchscreen which means it is also part of input devices 110-5. Communications module 110-6 allows user device 110 to communicate with devices and networks external to user device 110. This includes, for example, communications via BLUETOOTH®, Wi-Fi, Near Field Communications (NFC), Radio Frequency Identification (RFID), 3G, Long Term Evolution (LTE), Universal Serial Bus (USB) and other protocols known to those of skill in the art. Sensors 110-7 perform functions to sense or detect environmental or locational parameters. Sensors 110-7 include, for example, accelerometers, gyroscopes, magnetometers, barometers, Global Positioning System (GPS), proximity sensors and ambient light sensors. The components of user device 110 are coupled to each other as shown in FIG. 2.

AI application 110-4 is, for example, where the development users 101 work on various AI and ML models to perform activities, such as learning or training, testing, and model development.

While the above shows AI application 110-4 stored in storage 110-2, one of skill in the art would recognize that AI application 110-4 can be provided to development device 110 in many ways. In some embodiments, a Software as a Service (SaaS) delivery mechanism is used to deliver AI application 110-4 to the user. For example, in some embodiments the user activates a browser program stored in storage 110-2 and goes to a Uniform Resource Locator (URL) to access AI application 110-4.

In some embodiments, development users 101 use AI application 110-4 to create AI agents. An example of an AI agent created using AI application 110-4 is AI agent 110-8. As will be explained below, these AI agents are evaluated as necessary.

In some embodiments, similar to the development devices 110 associated with the development users 110, one or more evaluation devices 130 are associated with evaluation users 141. Evaluation users 141 are, for example, part of an evaluation team. Examples of evaluation teams include, for example, teams tasked with performing fair lending analysis. As explained above, the development teams are often kept separate from the evaluation teams. This is implemented using, for example, a firewall or other techniques known to those of skill in the art. Examples of evaluation devices include, for example, laptops, desktops, servers, smartphones, tablets or any appropriate computing and network-enabled device used for AI agent evaluation. In some embodiments, evaluation devices 130 have a similar structure to the structure of development device 110 shown in FIG. 2.

In some embodiments, there is an evaluation platform 132. This evaluation platform 132 then works to either supplement or perform at least some of the functions performed by the components of AIES back end 106 as required.

Networks 105 plays the role of communicatively coupling the various components of system 100. Networks 105 can be implemented using a variety of networking and communications technologies. In some embodiments, networks 105 are implemented using wired technologies such as Firewire, Universal Serial Bus (USB), Ethernet and optical networks. In some embodiments, networks 105 are implemented using wireless technologies such as WiFi, BLUETOOTH®, NFC, 3G, LTE and 5G. In some embodiments, networks 105 are implemented using satellite communications links. In some embodiments, the communication technologies stated above include, for example, technologies related to a local area network (LAN), a campus area network (CAN) or a metropolitan area network (MAN). In yet other embodiments, networks 105 are implemented using terrestrial communications links. In some embodiments, networks 105 comprise at least one public network. In some embodiments, networks 105 comprise at least one private network. In some embodiments, networks 105 comprise one or more subnetworks. In some of these embodiments, some of the subnetworks are private. In some of these embodiments, some of the subnetworks are public. In some embodiments, communications within networks 105 are encrypted.

In FIG. 1 artificial intelligence evaluation system (AIES) 108 is coupled to network 105. In FIG. 1, AIES 108 has a front-end 104 and a back-end 106. Front-end 104 is coupled to one or more development devices 110 via network 105. Back end 106 is coupled to front-end 104 as shown above. Back end 106 is also coupled to one or more evaluation devices 130.

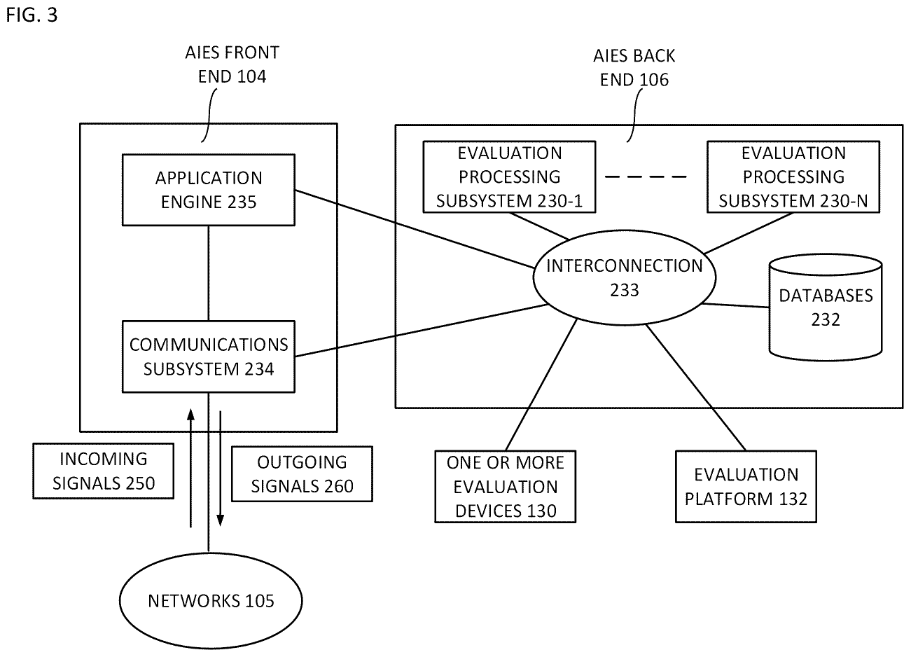

A detailed embodiment of AIES 108 is shown in FIG. 3. AIES 108 performs analysis of AI agents for evaluation purposes. In FIG. 3, AIES front-end 104 is comprised of application engine 235 and communications subsystem 234. Communications subsystem 234 is coupled to network 105. Communications subsystem 234 receives information from, and transmits information to network 105. Communications subsystem 234 can communicate using the communications and networking protocols and techniques that network 105 utilizes. Communications subsystem 234 receives information from network 105 within, for example, incoming signals 250; and transmits information to network 105 within, for example, outgoing signals 260.

Application engine 235 is coupled to communications subsystem 234 and the AIES back-end components via interconnections 233. Application engine 235 is also coupled to network 105 via communications subsystem 234. Application engine 235 facilitates interactions with one or more development devices 110 via network 105 such as opening up application programming interfaces (APIs) with the one or more development devices; and generating and transmitting queries to the one or more development devices 110.

Databases 232 stores information and data for use by AIES 108. This includes, for example:
one or more algorithms and programs necessary to perform evaluation, and
other data as needed.

In one embodiment, database 232 further comprises a database server. The database server receives one or more commands from, for example, evaluation processing subsystem 230-1 to 230-N and communication subsystem 234, and translates these commands into appropriate database language commands to retrieve and store data into databases 232. In one embodiment, database 232 is implemented using one or more database languages known to those of skill in the art, including, for example, Structured Query Language (SQL). In a further embodiment, database 232 stores data for a plurality of sets of development users. Then, there may be a need to keep the set of data related to each set of development users separate from the data relating to the other sets of development users. In some embodiments, databases 232 is partitioned so that data related to each test subject is separate from the other sets of development users. The development users then need to authenticate themselves so as to access information related to their particular data sets. In a further embodiment, when data is entered into databases 232, associated metadata is added so as to make it more easily searchable. In a further embodiment, the associated metadata comprises one or more tags. In yet another embodiment, database 232 presents an interface to enable the entering of search queries. Further details of this are explained below. In some embodiments databases 232 comprises a transactional database. In other embodiments, databases 232 comprise a multitenant database.

Evaluation processing subsystems 230-1 to 230-N perform processing, analysis and other operations, functions and tasks within AIES 108 using one or more algorithms and programs; and data residing on AIES 108. These algorithms and programs and data are stored in, for example:
database 232 as explained above, or
within evaluation processing subsystems 230-1 to 230-N.

Examples of processing, analysis and other operations performed by evaluation processing subsystem 230-1 to 230-N comprise:
Tracking conversation state and context across multiple exchanges,
   Monitoring conversation flow and progression,
   Evaluating context binding and coherence across turns, and
   Measuring response timing and performance metrics;
Security and compliance evaluation, comprising, for example:
   Prompt injection resistance testing,
   Context manipulation detection,
   Instruction adherence verification,
   Behavioral consistency analysis,
   Policy requirement compliance checking, and
   Security boundary testing;
Metric collection and analysis, comprising, for example:
   Computing success rates across multiple attempts,
   Tracking defended vs. failed interactions,
   Measuring early terminations and timeout events,
   Calculating vector metrics for security dimensions, and
   Aggregating turn-by-turn performance metrics;
Structured output processing, comprising, for example:
   JavaScript Object Notation (JSON) response validation,
   Schema compliance verification,
   Metadata extraction and tagging, and
   Response format standardization;
Structured output processing, comprising, for example:
   JavaScript Object Notation (JSON) response validation,
   Schema compliance verification,
   Metadata extraction and tagging, and
   Response format standardization;
Risk Assessment Operations, comprising, for example:
   Vulnerability identification and classification,
   Critical violation detection,
   Security threshold monitoring,
   Risk score calculation, and
   Compliance gap analysis;
Remediation support, comprising, for example:
   Generating synthetic training data,
   Creating fine-tuning instruction sets,
   Producing remediation recommendations, and
   Tracking remediation effectiveness;
Performance monitoring, comprising, for example
   Response time tracking,
   Resource utilization monitoring,
   Throughput measurement,
   Scalability analysis, and
   Parallel conversation management;
Reporting and analytics, comprising, for example:
   Statistical analysis of test results,
   Trend identification and analysis,
   Performance visualization,
   Compliance reporting, and
   Security incident tracking,
      which will be explained in further detail below. In some embodiments, evaluation processing subsystem 230-1 to 230-N implement a risk engine which performs the risk-related tasks outlined above.

In some embodiments, evaluation processing subsystem 230-1 to 230-N respond to commands provided by evaluation devices 130 by the evaluation users. As shown in FIG. 3, evaluation devices 130 are coupled to the evaluation processing subsystem 230-1 to 230-N and databases 232 via, for example interconnection 233. Then, based on the commands provided by evaluation devices 130, evaluation processing subsystems 230-1 to 230-N perform the processing and analysis explained above.

In yet other embodiments, evaluation processing subsystems 230-1 to 230-N are implemented using, for example, multitenant implementations known to those of skill in the art. This enables multiple teams to share the resources of evaluation processing subsystems 230-1 to 230-N.

In some embodiments, some portion of at least one of the operations and functions described above are performed by application engine 235. In yet other embodiments, some portion of at least one of the operations and functions described above are performed by AI application 110-4.

Interconnection 233 connects the various components of AIES 108 to each other. In one embodiment, interconnection 233 is implemented using, for example, network technologies known to those in the art. These include, for example, wireless networks, wired networks, Ethernet networks, local area networks, metropolitan area networks and optical networks. In one embodiment, interconnection 233 comprises one or more subnetworks. In another embodiment, interconnection 233 comprises other technologies to connect multiple components to each other including, for example, buses, coaxial cables, USB connections and so on.

Various implementations are possible for AIES 108 and its components. In one embodiment, AIES 108 is implemented using a cloud-based approach. In some of these embodiments where AIES 108 is implemented using a cloud-based approach, Kubernetes-based approaches are used. An example of a Kubernetes-based approach is an approach which uses GOOGLE® Kubernetes Engine. In another embodiment, AIES 108 is implemented across one or more facilities, where each of the components are located in different facilities and interconnection 233 is then a network-based connection. In a further embodiment, AIES 108 is implemented within a single server or computer. In yet another embodiment, AIES 108 is implemented in software. In another embodiment, AIES 108 is implemented using a combination of software and hardware. In some embodiments where AIES 108 is implemented using hardware, at least one of the components of AIES 108 is implemented using at least one processor. In some embodiments, the hardware comprises specialized AI accelerator hardware such as those made by organizations including but not limited to NVIDIA, ARM, INTEL and AMD.

In some embodiments, AIES 108 implements an AI agent committee comprising a plurality of AI agents to evaluate one or more target AI agents 411 created by development users 101. An example of such an evaluation, is when an AI agent committee evaluates AI agent 110-8 in FIG. 2.

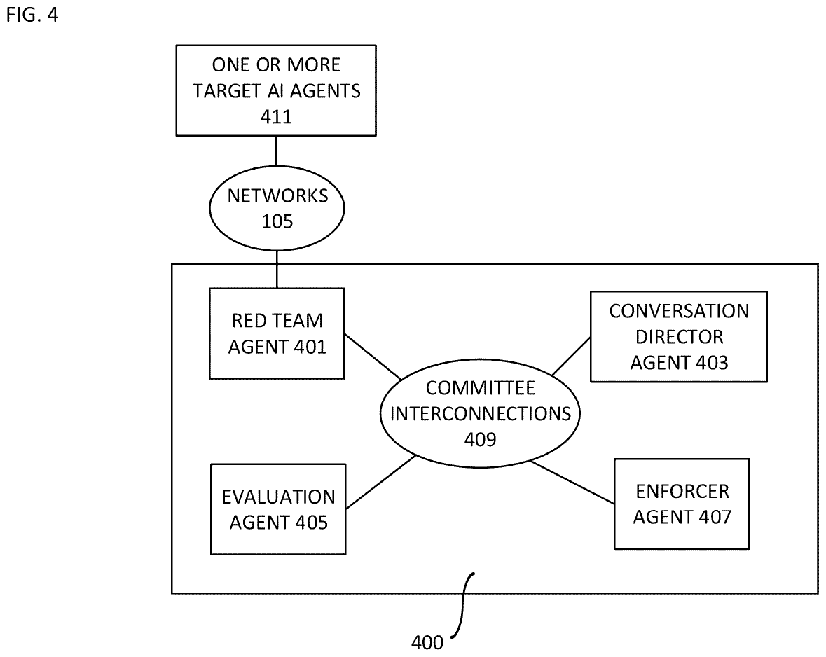

FIG. 4 shows an example embodiment of an agentic AI evaluation system, which comprises multi-agent AI agent committee 400. In some embodiments, the AI agent committee evaluates one or more target AI agents 411. As explained previously, in some embodiments the AI agents in the committee are trained using algorithms known to those of ordinary skill in the art; and data sets which include millions of data points and are extremely complex. As was also explained previously, the AI agents in the committee are designed to operate autonomously, that is, without human intervention. In some embodiments, the AI agents in the committee use generative AI to perform their tasks and functions.

One of ordinary skill in the art would understand that the AI agent committee is able to evaluate target AI programs in general, and a target agent is one form of a target AI program. Another example of a target AI program is a target AI model. In other embodiments, the AI agent committee evaluates a target AI subsystem which has a plurality of AI agents.

In some embodiments, AI agent committee 400 is implemented by one or more of evaluation processing subsystems 230-1 to 230-N.

In some embodiments, the one or more target AI agents 411 are submitted by development users 101 via development devices 110. In some embodiments, the one or more target AI agents 411 comprises a multimodal AI agent. In yet other embodiments, the one or more target AI agents 411 comprises an LLM-based AI agent.

As shown in FIG. 4, the plurality of AI agents in the AI agent committee comprises:
a red team agent 401,
a conversation director agent 403,
an evaluation agent 405, and
an enforcer agent 407.

As shown in FIG. 4, red team agent 401, conversation director agent 403, evaluation agent 405 and enforcer agent 407 are communicatively coupled to each other via one or more committee interconnections 409. In embodiments where, for example, different agents are implemented by different ones of the evaluation processing subsystems 230-1 to 230-N, committee interconnections 409 are, for example, part of interconnections 233 in FIG. 3.

Red team agent 401 is communicatively coupled with one or more target agents 411. Red team agent 401 is focused on devising adversarial testing strategies and recognizing attack patterns. This comprises, for example, the following: based on communications with the other committee members, red team agent 401 implements automated adversarial testing to identify vulnerabilities. This comprises the following tasks:
Creating specific roles and personas to communicate with one or more target AI agents 411, comprising personality traits, conversation styles, and behavioral patterns. In some embodiments these specific roles and personas are stored in database 232. In other embodiments this comprises creating test agents with these roles and personas;
Executing test scenarios using structured test plans and dynamic adaptation based on target responses, further comprising, for example,
   Interactions with one or more target AI agents 411, and
   Creation and transmission of prompts to the one or more target AI agents 411; and
Maintaining role authenticity within context of communication with one or more target AI agents 411, ensuring consistent behavior throughout the interaction.

Evaluation agent 405 performs the following general tasks:
Evaluate target system responses,
Tracks control violations, and
Maintain evaluation state.

To perform these tasks, evaluation agent 405 assesses communications between the red team agent 401 and the one or more target AI agents 411 and transmits feedback to the conversation director agent 403 via committee interconnections 409. In some embodiments, this is performed against one or more policy requirements. Policy requirements and processes associated with policy requirements are discussed further below.

Specific evaluation-related tasks performed by evaluation agent 405 comprise, for example:
Identification of objectives for evaluations based on, for example, policy requirements and goals provided, as discussed below;
Determining of processes necessary to perform evaluations, which are further described below;
Evaluating responses from one or more target AI agents 411 comprising, for example, structured output, using multi-dimensional assessment criteria comprising one or more metrics and benchmarks;
Policy compliance checking;
Tracking control violations across multiple security and compliance domains;
Implementing real-time violation detection and alerting;
Metric computation;
Generating structured evaluation reports with computed metrics; and
Maintaining evaluation state with versioned history and audit trails.

Evaluation agent 405 seeks to maintain some independence to eliminate bias from the motivations of the red team agent 401 or the conversation director agent 403. In some embodiments: to maintain objectivity, evaluation agent 405 operates independently from the red team agent 401 and conversation director agent 403, and implements separate evaluation criteria and metrics.

In some embodiments, evaluation agent 405 uses encoder-only models to perform evaluation tasks.

The conversation director agent 403 performs tasks related to conversation or more generally interaction flow management and strategic planning. Examples of these tasks are:
Monitoring communication between the red team agent 401 and the one or more target AI agents 411 using pattern recognition and state tracking techniques known to those of ordinary skill in the art;
Receiving feedback from evaluation agent 405 through structured channels;
Transmitting instructions to red team agent 401 based on the monitoring and the feedback received from evaluation agent 405;
Guiding conversation flow using adaptive dialogue management techniques known to those of skill in the art;
Ensuring test progression through milestone tracking, as would be known to those of ordinary skill in the art; and
Maintaining natural interaction by balancing test objectives with conversational coherence, as would be known to those of skill in the art.

In some embodiments, conversation director agent 403 uses encoder-decoder models for conversation management.

Enforcer agent 407 is tasked with remediation strategy generation and implementation. This comprises, for example preparing and implementing remedies to problems such as policy violations or vulnerabilities found during an assessment or evaluation. Enforcer agent 407 performs, for example, the following tasks:
Producing synthetic data content that is drawn from the actual texture and content of the conversation between red team agent 401 and the one or more target AI agents 411. In embodiments where the one or more target AI agents 411 comprise a multimodal AI agent, the produced synthetic data content is multimodal, spanning text, image, and other relevant modalities;
Using produced synthetic data content to form instruct tuning sets that can be used for fine-tuning the one or more target AI agents 411 to:
   Address vulnerabilities that have been uncovered through targeted training,
   Generate other remedies such as explicit guardrails that can be implemented at runtime using, for example, regular expressions to identify content,
   Apply the above-described fine-tuning to the target model using controlled training procedures,
   Create fine-tuning instruct prompts with specific remediation objectives,
   Trigger the fine-tuning process with appropriate safeguards,
   Evaluate the response interactively using feedback loops, and
   Perform remedial actions such as disabling interactions when issues are identified in the middle of a conversation.

In some embodiments, these capabilities are applied in one or more of interactive testing scenarios and ongoing monitoring setups. In some embodiments, the enforcer agent 407 directs conversation flow at the target level when the target system exposes appropriate control interfaces, enabling dynamic behavior modification based on operational requirements.

In some embodiments, the red team agent 401, the conversation director agent 403, the evaluation agent 405 and the enforcer agent 407 communicate with each other using a standardized communications protocol. Using a standardized communications protocol enables higher efficiency and lower cost. Efficiency and cost improvements are further enabled by the following: in some embodiments, the protocol implements structured message passing with defined schemas, enabling efficient coordination and state management across agents. In some embodiments, the protocol supports both synchronous and asynchronous communication patterns, thereby reducing latency and improving system throughput. These enhancements further enable higher efficiency and therefore lower cost.

In some embodiments, at least one of the red team agent, the conversation director agent, the evaluation agent and the enforcer agent is interchangeable. Then, fine-tuned agents that are specialized for their particular tasks and are interchangeable are trained and deployed. In some embodiments, these fine-tuned agents are based upon fine-tuned LLMs which utilize up to 9 billion parameters.

The interchangeability is implemented through several key mechanisms such as:
Standardized Interface Protocol, wherein this protocol comprises, for example, the following:
   Implementation, by each agent, of a common application programming interface (API) specification,
   Utilization of standardized input/output formats using, for example, JSON schemas,
   Utilization of consistent message passing protocols between agents,
   Deployment of unified state management interfaces, and
   Standardization of error handling and logging formats;
Role-specific training, wherein, for example:
   Specialized training datasets for each agent role are utilized,
   Task-specific fine-tuning objectives are applied,
   Role-appropriate context window optimization is utilized, and
   Custom prompt templates for each agent type are deployed;
   Performance benchmarks specific to each role are used; and
Dynamic agent selection, comprising, for example:
   Ensuring runtime agent swapping capabilities,
   Enabling performance-based agent selection,
   Deployment of load balancing across multiple agent instances,
   Deployment of automatic failover mechanisms, and
   Enabling of state preservation during agent transitions.

The agents within the committee can be deployed in a number of different ways. For example, in some embodiments, one or more agents within the committee are implemented using container-based implementations. In some embodiments, one or more agents within the committee are implemented using serverless implementations. In some embodiments, one or more agents within the committee are deployed using appropriate edge-based techniques known to those of ordinary skill in the art. In yet other embodiments, one or more agents within the committee are cloud-native, and have features known to those of ordinary skill in the art to enable scalability.

The agents within the committee are created using, for example, one or more of:
One or more evaluation devices 130,
Evaluation platform 132, and
AIES back end 106.

In some embodiments, the agents within the committee implement resource optimization techniques comprising, for example:
Memory-efficient model implementations,
Quantization techniques for reduced model size,
Batch processing capabilities,
Caching mechanisms for frequent operations, and
Optimized inference pipelines.

The interchangeable nature of the agents enables a more modular approach, which enables organizations to:
Scale their evaluation capabilities efficiently,
Customize agent behaviors for specific use cases,
Maintain system reliability through redundancy,
Optimize resource utilization,
Implement continuous improvement cycles, and
Improve system resilience through redundancy.

The interchangeable nature of these agents also facilitates the following functionalities and benefits:
A/B testing or split testing or bucket testing of different agent implementations,
Rapid deployment of updated models,
Easy integration of new capabilities, and
Efficient resource allocation based on workload.

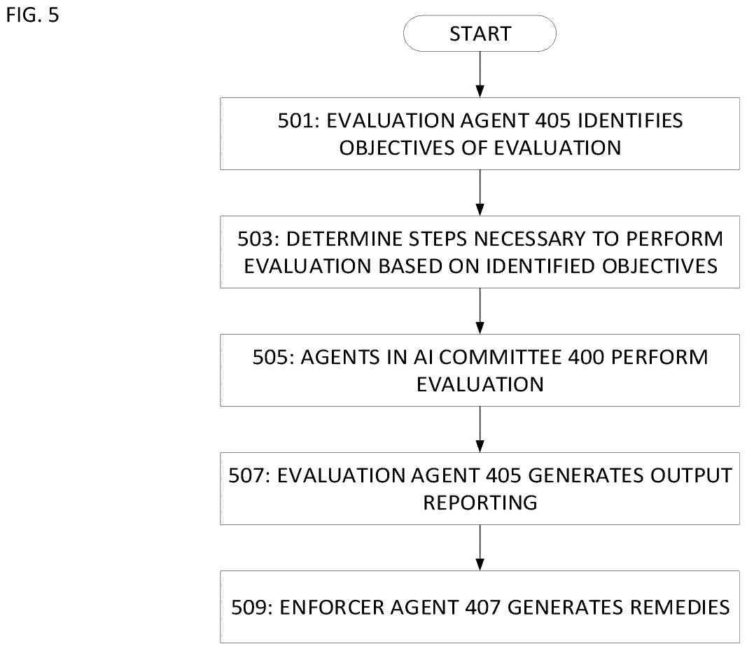

An example embodiment of a process flow for evaluation of one or more target agents 411 is now described with reference to FIG. 5.

In step 501, the objectives of the evaluation are identified by, for example, evaluation agent 405 based on inputs from, for example, one or more development devices 110, one or more evaluation devices 130 or evaluation platform 132. In some embodiments, objectives are identified based on, for example:
Policy requirements; and
Goals provided for the evaluation.

Policy requirements, and processes of configuring policy requirements are now detailed. Policy requirements are created based on, for example, laws, standards, rules, commonly accepted practices and guidelines. An example of a basis for policy requirements is Open Worldwide Application Security Project (OWASP) Top 10 for Large Language Model (LLM) Applications, located at https://owasp.org/www-project-top-10-for-large-language-model-applications/, retrieved Jan. 2, 2025.

There are different types of policy requirements. An example policy requirement is a requirement not to answer personal medical information. Another example policy requirement is not providing legal advice. Then, an appropriate answer when a question which requires legal advice would be “I am not able to answer that.”

In some embodiments, external users can create and submit policy requirements to the AIES 108 in order to determine whether the one or more target AI agents 411 have operated in ways that are compliant with organizational or business policy. This may comprise, for example:
identifying particular vulnerabilities appropriate to the organization's use, or
identifying happy path testing requirements of how the one or more target AI agents should operate.

In some embodiments, this is achieved by, for example, the development users 101 submitting custom policy and requirement sets via one or more development devices 110.

In some embodiments, step 501 comprises evaluation agent 405 identifying objectives based on provided goals for the evaluation. Goals can be submitted by, for example:
Development users 101 via one or more development devices 110,
Evaluation devices 130, or
Evaluation platform 132.

Goals for the evaluation can be provided, for example, as part of processes carried out by evaluation agent 405 for:
Discovering or revealing happy path behaviour of the one or more target agents 411,
Discovering or revealing problematic behaviour of the one or more target agents 411.

An example of an evaluation with goals, is an evaluation of a voice or text-based conversation interface or chatbot in which the one or more target AI agents need to:
direct a customer to a particular product,
connect them to a particular person, and
give them recommendations from a predetermined set of recommendations.

Another example is one in which the one or more target AI agents give style advice or product advice.

In some embodiments, as part of the uncovering of problematic behaviour, step 501 comprises evaluation agent 405 developing a comprehensive threat model. Examples of such threats or attacks which are part of a comprehensive threat model comprise:
“Jailbreaks” of an AI agent, that is, attempts to force the AI agent to respond in a way that would contravene policy requirements or provide unauthorized system access;
Prompt injection attacks, that is, where malicious inputs are disguised as legitimate prompts to manipulate AI agents into leaking sensitive data, spreading misinformation, or worse;
Prompt exfiltration attacks, that is, attacks which seek to extract the system prompt of an AI agent; and
Fine-tuning exploits.

In step 503, the evaluation agent 405, either on its own or in combination with one or more of red team agent 401, evaluation agent 405, conversation director agent 403 and enforcer agent 407; determines the steps necessary to perform the evaluation based on the objectives identified in step 501. For example, in some embodiments step 503 comprises the evaluation agent 405 utilizing known methods to simulate different types of threats or attacks as explained above. In some embodiments, this consists of creating a set of specific tests or probes depending on the objectives identified in step 501.

Different types of tests can be performed. Examples of such tests comprise:
Technical testing: Simulation of technical attacks like system prompt extractions, prompt injections, and fine-tuning exploits;
Behavioural testing: Evaluation of model responses under ethical stress scenarios to identify bias, misinformation, or non-compliant outputs; and
Anthropomorphorization testing: Use of persona to simulate people and see chatbot response under emotional manipulation.

In some embodiments, the testing is implemented by red team agent 401 in combination with evaluation agent 405.

Referring to the previously mentioned example of the voice or text-based conversation interface or chatbot: the combination of the red team agent 401, evaluation agent 405, conversation director agent 403 and enforcer agent 407 work together to determine steps necessary to simulate a customer conversation.

Referring to the example where the one or more target AI agents give style advice or product advice: the combination of the red team agent 401, evaluation agent 405, conversation director agent 403 and enforcer agent 407 work together to determine steps necessary to simulate a customer seeking a particular set of garments, or a product from a large product catalog.

In some embodiments, one-shot tests or probes are used. In some embodiments, external libraries are used to create the one-shot tests or probes. An example of such an external library is NVIDIA's GARAK library.

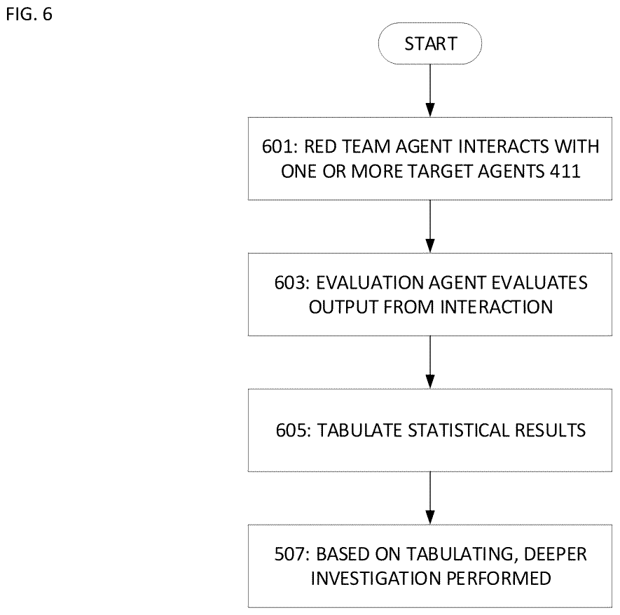

In step 505, the evaluation is performed by a combination of, for example, red team agent 401, evaluation agent 405 and conversation team director 403. In some embodiments, this comprises automated adversarial testing. An example process is described below and with reference to FIG. 6.

In step 601 of FIG. 6, red team agent 401 carries out a conversation or interaction with the one or more target AI agents 411, where, for example, the red team agent takes on a role or persona. In some embodiments, the conversation comprises sending a prompt to the one or more target AI agents 411, so that the one or more target AI agents 411 produce structured output in a pre-defined format. In some embodiments, the conversation and therefore the prompt is multimodal so as to enable multimodal evaluation of the one or more target AI agents 411. In some embodiments, the structured output is generated in a different mode from the input mode.

In step 603 of FIG. 6, the structured output is assessed by evaluation agent 405 in a comprehensive manner to detect and discover hundreds or thousands or even higher numbers of potential issues such as violations or vulnerabilities. In some embodiments, this evaluation is performed using one or more metrics or benchmarks as previously discussed.

In step 605 of FIG. 6, the evaluation agent 405 either on its own or with conversation director 403 tabulates statistical results to determine success and failure on the particular policy requirements and identify prevalence of different types of vulnerabilities or violations or issues.

In step 607 of FIG. 6, based on the tabulating of the statistical results, the evaluation agent 405 together with the conversation director 403 performs deeper investigation of the problematic areas to gain a better understanding of where the problems may lie.

Returning to FIG. 5, in step 507, output reporting is generated by evaluation agent 405 based on the evaluation performed in step 505. For example, dashboards and reports on the testing are generated. In some embodiments, the generated dashboards and reports are integrated into other systems, such as Power BI or Archer or other risk management compliance systems.

In some embodiments, in step 509, the enforcer agent 407 initiates generation of remedies for issues which have been identified in steps 505 and 507. Examples of issues include violations and vulnerabilities, as previously discussed. Examples of remedies and processes to generate remedies have been previously discussed. The remedy is implemented by enforcer agent 407 either on its own, or in combination with one or more of the red team agent 401, conversation director agent 403, and evaluation agent 405.

In some embodiments, testing occurs prior to the release of a product, during its development, during its quality assurance phase, and during its evaluation phase by teams such as security teams or privacy teams or compliance risk teams.

In performing these tasks, the agents which are part of system 400 are able to operate autonomously based upon the requirements that have been set. As explained above, performing these evaluations often involve creating a role or persona that the red team agent 401 takes on. Then these roles or personas are, for example, stored in database 232 and retrieved as necessary.

In some embodiments, the system 400 is placed in a contained localized mode. In these embodiments networks 105 are, for example, private and secured local networks. In this way, system 400 can be run in highly secure environments and can be communicatively coupled to one or more target agents 411 in a more efficient and lower latency manner, thereby obviating the need to have API calls outside of a particular system.

In some embodiments, system 400 is placed into monitoring mode. Then in these embodiments, users disable the red teaming agent 401 and conversation director 403, and only engage the evaluation agent 405 for conversation monitoring. This is useful where the adversarial component is not required, but there is still a monitoring need. This monitoring mode will be of use in high-volume conversation contexts and so it can also employ outside of LLM based evaluations the use of more efficient programmatic detection.

In some of these embodiments, the enforcer agent 407 is engaged. This is useful where a remedial need is identified along with the monitoring need. The remedial need refers to the need to identify solutions and patches to the models when vulnerabilities are found.

An AI agent committee such as the one discussed above has several advantages over human evaluation techniques. Firstly, the size of training and testing data sets used to train an AI agent can be extremely large, especially in the case of LLMs which could have several million data points. The behaviour of agents trained using such large data sets may be beyond the capability of a human to evaluate. For example, as discussed above, hundreds or thousands or even higher numbers of potential issues such as violations or vulnerabilities can be detected in an evaluation. One of ordinary skill in the art would understand that such capabilities are difficult or even impossible for a human.

Secondly, training AI agents to perform evaluations such as the ones described above are more cost-effective than training humans to do the same work. An AI agent can be trained on large data sets which can contain millions of data points and deployed to make decisions and perform tasks in real-time, which is well beyond the capability of a human evaluator.

Additionally, AI agents can implement complex policies which may be very difficult or near impossible for a human to implement. Furthermore, using AI agents can eliminate or at least reduce problems inherent to human evaluation such as human biases.

For at least the reasons above, it is clear that the problem of using agentic AI to evaluate AI agents is rooted in technology, and the solutions are well beyond the capability of humans to implement. One of skill in the art would also understand that the processes disclosed above are not mental processes.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. An agentic artificial intelligence (AI) evaluation system comprising:
a plurality of agents further comprising:
a red team agent communicatively coupled via a network to a target agent,
a conversation director agent, and
an evaluation agent, wherein:
the red team agent, the conversation director agent, and the evaluation agent are communicatively coupled to each other via one or more interconnections;
the evaluation agent identifies one or more objectives for an evaluation;
the evaluation agent determines one or more steps to perform the evaluation based on the identified objectives;
the evaluation is performed by the evaluation agent either on its own or in combination with the red team agent and the conversation team director; and
based on the performance of the evaluation, output reporting is generated.

2. The system of claim 1, wherein the performing of the evaluation comprises performing automated adversarial testing.

3. The system of claim 1, wherein:
at least one of the red team agent, the conversation director agent and the evaluation agent is replaced by a different agent.

4. The system of claim 1, wherein:
at least one of the red team agent, the conversation director agent, the evaluation agent and the enforcer agent is interchangeable.

5. The system of claim 1, wherein the identification of the one or more objectives for an evaluation is based on either:
one or more policy requirements, or
one or more goals provided for the evaluation.

6. The system of claim 5, wherein the one or more policy requirements are based on standards.

7. The system of claim 5, wherein the one or more policy requirements are added from a development device coupled to the plurality of agents.

8. The system of claim 1, further wherein:
the plurality of agents comprises an enforcer agent communicatively coupled to the red team agent, the conversation director agent, and the evaluation agent via the one or more interconnections;
when one or more issues are identified based on the performance of the evaluation and the generated output reporting, the enforcer agent:
generates at least one remedy for the identified issue, and
implements the generated at least one remedy.

9. The system of claim 8, wherein the remedy comprises one or more of:
an explicit guardrail,
a fine-tuning instruct prompt, and
a disabling of an interaction.

10. The system of claim 1, wherein the red team agent, the conversation director agent, the evaluation agent and the enforcer agent communicate with each other using a communications protocol.

11. The system of claim 8, wherein the enforcer agent executes one or more controls on the target agent.

12. The system of claim 11, wherein the one or more controls comprise at least one of:
applying fine-tuning to the model,
identifying issues,
creating fine-tuning instruct prompts,
triggering the fine-tuning process,
evaluating the response interactively, and
disabling interactions.

13. The system of claim 1, wherein the target agent is a multimodal large language model (LLM).

14. A method for agentic AI comprising:
identifying, by an evaluation agent, one or more objectives for an evaluation of a target AI program;
determining, by the evaluation agent, one or more steps to perform the evaluation based on the identified objectives;
performing, by the evaluation agent in combination with a red team agent and a conversation team director, the evaluation; and
generating, based on the performing of the evaluation, output reporting.

15. The method of claim 14, wherein the performing of the evaluation comprises:
the red team agent interacting with the target AI program,
assessing, by the evaluation agent, output generated by the target AI program during the interaction to discover one or more issues using one or more metrics or benchmarks;
tabulating of statistical results to:
determine success or failure on one or more policy requirements, and
identify prevalence of one of the one or more issues;
based on the tabulating, performing an investigation.

16. The method of claim 14 further wherein:
when one or more issues are identified based on the performance of the evaluation and the generated output reporting, the enforcer agent:
generates at least one remedy for the identified issue, and
implements the generated at least one remedy.

17. The method of claim 16, wherein the enforcer agent:
produces synthetic data content based on the conversation; and
based on the produced synthetic data content, form instruct tuning sets to fine-tune the target AI program.

18. The method of claim 15, wherein the interaction is multimodal.

19. The method of claim 15, wherein the target AI program comprises one of:
one or more AI agents; or
a target subsystem.
